(19) United States
(12) Patent Application Publication
(10) Pub. No.: US 2024/0156247 A1
(43) Pub. Date: May 16, 2024

(54) Method For Producing A Cleaning Device, And Cleaning Device

(71) Applicant: LUORO GMBH, Köln (DE)

(72) Inventor: Louis Bahlmann, Köln (DE)

(21) Appl. No.: 18/282,276

(22) PCT Filed: Mar. 15, 2022
(86) PCT No.: PCT/EP2022/056609

§ 371 Date: Sep. 15, 2023

(30) Foreign Application Priority Data
Mar. 17, 2021 (DE) 10 2021 202 595.1

(51) Int. Cl. A46D 3/04; A46D 1/00

(52) U.S. Cl. CPC A46D 3/047; A46D 1/0207; A46B 2200/1066; A46D 99/00

(57) ABSTRACT

A cleaning apparatus or an interdental cleaning apparatus and a method for producing a cleaning apparatus or an interdental cleaning apparatus, the method includes: forming a gripping element from a fiber material or from paper or card, providing a cleaning element which comprises at least one filament, arranging at least a portion of the at least one filament of the cleaning element in a receiving portion of the gripping element, connecting the cleaning element to the gripping element by: pressing the receiving portion of the gripping element, or pressing the receiving portion from several sides against the portion, which is arranged in the receiving portion of the filament and/or introducing heat into the receiving portion and/or the portion of the filament.

### CROSS-REFERENCE TO RELATED APPLICATIONS

This application is a US National Stage Entry of PCT/EP2022/056609 filed on Mar. 15, 2022, which claims priority to DE 10 2021 202 595.1 filed on Mar. 17, 2021.

### FIELD

The present invention relates to a method for producing a cleaning apparatus, in particular an interdental cleaning apparatus.

### BACKGROUND

A cleaning apparatus which is in the form of an interdental cleaning apparatus is described, for example, in JP 6501926 B2. This interdental cleaning apparatus comprises a gripping portion which is made from paper and a brush portion. In JP 6501926 B2, it is proposed to construct the gripping portion integrally with the brush portion. Although, as a result of such an integral production, a good retention of the brush portion on the gripping portion is enabled, the integral production requires a complex production process.

WO 2021/140102 A1 further discloses a cleaning apparatus having a gripping element and a separate brush element, which has a base and filaments which are arranged on the base. In order to connect the cleaning element to the gripping element, a portion of the base of the cleaning element is arranged in a receiving portion of the gripping element.

### SUMMARY

An object of the present invention is to enable the production of a cleaning apparatus with the least possible complexity and a good retention between the gripping portion and brush portion.

In order to achieve the objective, a method for producing a cleaning apparatus, in particular an interdental cleaning apparatus is proposed. The method comprises the following method steps:
a. forming a gripping element from a fiber material, in particular from paper or card,
b. providing a cleaning element which comprises at least one filament,
c. arranging at least a portion of the at least one filament of the cleaning element in a receiving portion of the gripping element,
d. connecting the cleaning element to the gripping element by
   i. pressing the receiving portion of the gripping element, in particular pressing the receiving portion from several sides against the portion, which is arranged in the receiving portion, of the filament and/or
   ii. introducing heat into the receiving portion and/or the portion of the filament.

In order to achieve the objective, there is further proposed a cleaning apparatus, in particular an interdental cleaning apparatus, having a gripping element and a cleaning element which comprises at least one filament, wherein the gripping element is made from a fiber material, in particular from paper or card, and the cleaning element is connected to the gripping element, wherein at least a portion of the at least one filament is arranged in a receiving portion of the gripping element and is pressed and/or melted with the receiving portion.

According to the invention, a gripping element of the cleaning apparatus is made from a fiber material, in particular from paper or card. The gripping element may consequently after its use be recycled or biologically degraded. Furthermore, a cleaning element which comprises at least one filament is provided, for example, a brush element which comprises a plurality of filaments, or a cleaning element having a filament in the form of a dental floss filament. According to the invention, at least a portion of the at least one filament is arranged in a receiving portion of the gripping element. The cleaning element is then connected to the gripping element, wherein one or both of the method steps mentioned below are used. The connection can be carried out by pressing the receiving portion of the gripping element, in particular by pressing the receiving portion from several sides against the portion, which is arranged in the receiving portion, of the filament. Alternatively or additionally, heat can be introduced into the receiving portion and/or into the portion of the filament which is arranged in the receiving portion. In this manner, it may be possible for the portion of the filament which is arranged in the receiving portion to be pressed or melted with the receiving portion. A resistant connection between the gripping element and the cleaning element can thereby be enabled. In addition, it is possible for the cleaning element to be provided as a finished component which, in order to produce the cleaning apparatus, is connected to the gripping element, whereby the complexity for producing the cleaning apparatus can be reduced.

Preferably, the connection between the gripping element and the cleaning element is so resistant that it is released only under the action of a pull-out force greater than 15 N.

The gripping element and the cleaning element are in the form of separate elements of the cleaning apparatus, in particular interdental cleaning apparatus. Preferably, the gripping element and the cleaning element are made from different materials. Whilst the gripping element is made from a fiber material, in particular from paper or card, the cleaning element may be made from a material or a plurality of materials which do not comprise any fiber material, for example, a plastics material.

According to an advantageous embodiment of the invention, there is provision for the cleaning element to be a brush element which comprises a plurality of filaments, the method step of arrangement to comprise the arrangement of at least a portion of at least some of the filaments of the brush element in a receiving portion of the gripping element, the method step of connecting the brush element to the gripping element to comprise:
i. pressing the receiving portion of the gripping element, in particular pressing the receiving portion from several sides against the filaments or portions of the filaments which are arranged in the receiving portion, and/or
ii. introducing heat into the receiving portion and/or the filaments or portions of the filaments which are arranged in the receiving portion.

This embodiment thus comprises the following method steps:
a. forming a gripping element from a fiber material, in particular from paper or card,
b. providing a brush element which comprises a plurality of filaments,
c. arranging at least a portion of at least some of the filaments of the brush element in a receiving portion of the gripping element,
d. connecting the brush element to the gripping element by
   i. pressing the receiving portion of the gripping element, in particular pressing the receiving portion from several sides against the filaments or portions of the filaments which are arranged in the receiving portion, and/or
   ii. introducing heat into the receiving portion and/or the filaments or portions of the filament which are arranged in the receiving portion.

In the context of the invention, only portions of some or all filaments of the brush element may be arranged in the receiving portion or some of the filaments may be arranged completely in the receiving portion. According to this embodiment of the method according to the invention, a cleaning apparatus for cleaning interdental spaces with a gripping element and a brush element can be obtained.

The brush element may, for example, have a metal or a plastics material. Preferably, the brush element comprises a base on which the filaments are arranged. The base, may, for example, be rod-like. The base of the brush element is preferably made from a metal, for example, from a metal wire, in a particularly preferred manner from a plastics-coated metal wire. Alternatively, the base may be made from a plastics material, for example, from polypropylene (PP) or a thermoplastic elastomer material (TPE).

According to an alternative, advantageous embodiment, there is provision for
the method step of arrangement to comprise the arrangement of at least two portions, in particular two end portions of the filament, in each case in one of two receiving portions of the gripping element, and
the method step of connecting the cleaning element to the gripping element to comprise:
   i. pressing the receiving portions of the gripping element, in particular pressing the receiving portions from several sides against the portion of the filament which are arranged in the receiving portion, and/or
   ii. introducing heat into the receiving portions and/or the portions of the filament.

According to this embodiment of the method according to the invention, there can be obtained a cleaning apparatus which comprises a gripping element and a filament which is connected to the gripping element, for example, a dental floss filament, which is connected to the gripping element in two connection portions.

Preferably, the one or more filaments are made from a thermoplastic material, in particular from a polyamide (PA), polylactide (PLA), polymethyl methacrylate (PMMA), polycarbonate (PC), polyethylene terephthalate (PET), polybutylene terephthalate (PBT), polyurethane (PU), polyethylene (PE), polypropylene (PP), polystyrene (PS), polyetheretherketone (PEEK) or polyvinyl chloride (PVC).

According to an advantageous embodiment of the invention, there is provision for the brush element to comprise filaments with a relatively high melting point and filaments with a low melting point and for the filaments with the relatively high melting point to be arranged at a side of the brush element which faces away from the gripping element, in particular the receiving portion of the gripping element. Preferably, the filaments which are arranged in the receiving portion are those with a relatively low melting point. Such a configuration affords the advantage that the filaments or portions of the filaments which are arranged in the receiving portion already melt at a relatively low temperature and provide a connection between the brush element and the gripping element, whilst an undesirable melting of the filaments at the side of the brush element facing away from the gripping element can be prevented.

According to an advantageous embodiment of the invention, there is provision for the heat to be introduced by means of a heating element which is brought into contact with the receiving portion. The heating element may be a heat-sealing jaw or a roller. The receiving portion may be arranged in order to introduce the heat between the heating element and a counter-piece or between the heating element and another heating element. Preferably, the receiving portion is also pressed by the heating element. For example, the receiving portion may be pressed between the heating element and a counter-piece or between the heating element and another heating element.

Alternatively or additionally, there may be provision for the heat to be introduced by means of heated air. Such a configuration of the method according to the invention affords the advantage that the introduction of the heat can be carried out in a contactless manner. For example, a heated air flow can be produced by a hot air device and directed onto the receiving portion.

Alternatively or additionally, there may be provision for the heat to be introduced by means of ultrasound. With such a configuration, the heat can be introduced by means of a sonotrode into the receiving portion and/or the filament of the cleaning element or the filaments of the brush element. It is possible to also press the receiving portion using the sonotrode. For example, the receiving portion can be pressed between the sonotrode and a counter-piece.

According to an advantageous embodiment of the invention, there is provision for the heat to be introduced by heating an end region of the gripping element which is opposite the receiving portion. In this regard, the heat can be introduced from the opposing side of the gripping element into the receiving portion. In this manner, an undesirable heating of the regions of the cleaning element, in particular the filaments of the brush element which are not introduced into the receiving portion of the gripping element, can be prevented.

A configuration of the method in which the fiber material, in particular prior to forming the gripping element, is provided with a heat-sealable coating is advantageous. When the fiber material of the gripping element comprises a heat-sealable coating, when the opposing end region of the gripping element is heated, a connection of individual layers of the fiber material can be enabled at the same time. For example, using a heat-sealable material, coated, rolled layers of the fiber material can be sealed to each other by means of heating.

If the brush element has a base, on which the filaments are arranged, in particular a base made of a metal and/or a plastics material, the heat according to an advantageous embodiment of the invention can be introduced by heating the base. The base is suitable for introducing the heat, in particular when it is made from a material with high thermal conductivity, for example, a metal. For example, a heating device can be brought into contact with the base. The heating device may be integrated into a handling device, for example, a robot arm, with which the brush element is moved toward the gripping element.

According to an advantageous embodiment, the filaments or portions of the filaments of the brush element which are not arranged in the receiving portion are cooled, in particular cooled by means of air. The cooling can be carried out during the introduction of the heat into the receiving portion and/or the filaments or portions of the filaments which are arranged in the receiving portion. As a result of the cooling, an undesirable melting or adhesive bonding of the filaments which are arranged outside the receiving portion can be prevented.

Preferably, the gripping element is constructed in a rod-like manner. The receiving portion of the gripping element is preferably arranged at a front end of the rod-like gripping element. Preferably, the receiving portion comprises a recess, in particular a blind hole or a throughhole, which is open in the direction toward an end face of the rod-like gripping element. A cleaning apparatus in which the brush element is arranged in alignment with the gripping element can thereby be obtained.

According to an advantageous embodiment of the invention, there is provision for the receiving portion to comprise an end face of the gripping element and for the pressing and/or introduction of the heat to be carried out in a region of the receiving portion of the gripping element which has a spacing from the end face of the gripping element. In this manner, the probability can be reduced that filaments of the brush element which are arranged outside the receiving portion may be pressed and/or heated and may potentially melt or become adhesively bonded. The spacing is preferably at least 0.1 times a length of the cleaning element, in particular brush element, for example, at least 0.15 times the length of the cleaning element, in particular brush element, or 0.2 times the length of the cleaning element, in particular brush element. In a particularly preferred manner, the spacing is at least 0.25 times a length of the cleaning element, in particular brush element, for example, at least 0.3 times the length of the cleaning element, in particular brush element, or 0.35 times the length of the cleaning element, in particular brush element.

The pressing of the receiving portion can be carried out with a roller or a plurality of cooperating rollers. The roller may have a circular cross section. Alternatively, it is possible for the roller to have a non-circular cross section or to be rotatably supported about a rotation axis which does not correspond to the axis of symmetry of the roller. It may thereby be possible, when the gripping element is guided along the roller or when the gripping element is guided through cooperating rollers, for the gripping element to be pressed only in selected portions of the gripping element, in particular only in the receiving portion.

In an embodiment of the method according to the invention, in which the connection of the brush element to the gripping element is carried out by pressing the receiving portion, there is preferably provision for the gripping element, in particular the receiving portion of the gripping element, to be moistened, in particular softened. The connection of the gripping element and brush element can thereby be further promoted.

In an embodiment of the method according to the invention in which the connection of the brush element to the gripping element is carried out by pressing the receiving portion, there is preferably provision for heat to be produced by a relative movement of the gripping element and cleaning element, in particular brush element, relative to each other. Such a method is also referred to as friction welding. By means of friction, heating and/or melting of the material of the gripping element and/or cleaning element can be produced. Preferably, there may be provision for the gripping element and/or cleaning element to be preheated before arrangement of the at least one filament in the receiving portion. It is thereby possible for the at least one filament to be so powerfully heated already when introduced into the receiving portion that a connection to the gripping element is produced.

One advantageous embodiment makes provision for the fiber material, in particular the paper, to be rolled or wound in order to form the gripping element. Preferably, the fiber material is moistened before and/or during the rolling. As a result of the moistening, a water content greater than 15%, preferably greater than 20%, in a particularly preferred manner greater than 30%, is preferably produced in the fiber material, whereby the rolling of the paper can be simplified. The water content is preferably defined as a gravimetric water content, in particular in accordance with the standard ISO 11465. Alternatively or additionally, there may be provision for an adhesive to be applied to the fiber material before and/or during the rolling. The adhesive may reinforce the cohesion of the rolled fiber material. Furthermore, alternatively or additionally, there may be provision for the rolled fiber material of the gripping element to be coated with an adhesive after rolling. For rolling, the fiber material may be present as a layer or strip, in particular as a paper layer or paper strip. Preferably, the fiber material is pressed against a curved counter-face and carried by means of a conveying device, for example, a conveyor belt or a conveyor roller. The counter-face is preferably arranged in such a manner that a spacing between the counter-face and the conveying device decreases when viewed in a conveying direction. As a result of this spacing which becomes increasingly small, there is formed a gap in which the fiber material is rolled and forms a rod-like, rolled gripping element.

An alternative advantageous embodiment makes provision for the gripping element to be in the form of a fiber molded component by means of fiber pulp molding from the fiber material. The gripping element which is formed by means of fiber pulp molding may have a shaping which is predetermined by a tool which is used for the fiber pulp molding.

According to an advantageous embodiment of the invention, there is provision for at least one filament which is arranged in the receiving portion to be arranged, in particular bent over, in such a manner that it protrudes from the receiving portion, in particular at an end face of the gripping element. Preferably, a plurality of filaments are arranged in such a manner that they protrude from the receiving portion. Such a configuration affords the advantage that the filament(s) which protrude are not used only to connect the brush element to the gripping element, but instead can also provide cleaning power. In this regard, the protruding filaments perform a dual function.

An advantageous embodiment of the invention makes provision, in order to simultaneously form the gripping element and the receiving portion of the gripping element, for the fiber material of the gripping element to be rolled or wound around an in particular virtual winding axis in such a manner that a hollow space is formed along the winding axis. To this end, the fiber material can be rolled or wound around a winding member which takes the place of the hollow space and is removed after rolling.

According to an advantageous embodiment of the invention, there is provision for the receiving portion of the gripping element to be produced by means of drilling before connecting the cleaning element to the gripping element. An alternative, advantageous embodiment makes provision for the receiving portion of the gripping element to be produced before the cleaning element is connected to the gripping element or pressing in a mandrel. As a result of the drilling or pressing-in, a receiving portion having a blind hole, in which the filament(s) of the cleaning element, in particular brush element can be introduced, can be produced. The blind hole preferably has a diameter in the range from 0.3 mm to 3 mm, in a particularly preferred manner in the range from 0.5 mm to 1 mm.

A preferred embodiment makes provision, when the cleaning element, in particular brush element, is connected to the gripping element, for the receiving portion of the gripping element to be produced by pressing the cleaning element into the gripping element.

In this context, an embodiment has been found to be advantageous in which the gripping element, while the mandrel or the cleaning element is pressed in, has a water content greater than 15%, preferably greater than 20%, particularly preferably greater than 30%. The water content is preferably defined as a gravimetric water content, in particular in accordance with the standard ISO 11465.

One advantageous embodiment makes provision, in order to simultaneously form the gripping element and to connect the cleaning element to the gripping element, for the fiber material of the gripping element to be rolled or wound around some filaments or portions of some filaments of the cleaning element. The cleaning element can during the rolling or winding of the fiber material be retained and where applicable tracked with a retention device, for example, a robot arm.

According to an advantageous embodiment, there is provision in order to simultaneously form the gripping element and to connect the cleaning element, in particular brush element, to the gripping element for some filaments or portions of some filaments of the brush element to be arranged between a gripping element upper portion and a gripping element lower portion. The gripping element upper portion and/or the gripping element lower portion may be provided with a heat-sealable coating. The gripping element upper portion is preferably in the form of a portion of a plate-like upper portion element and the gripping element lower portion is in the form of a portion of a plate-like lower portion element. The plate-like upper portion element and/or the plate-like lower portion element may, for example, be card panels. The gripping element upper portion and the gripping element lower portion may after connection to the cleaning element, in particular brush element, in particular simultaneously, be released, in particular punched, from the respective upper portion element or lower portion element.

According to an advantageous embodiment of the invention, it is possible for the receiving portion of the gripping element to be pressed from more than two sides so that a pressed receiving portion having a triangular, rectangular, pentagonal or polygonal cross section or with a substantially circular cross section is obtained. Preferably, a cross section of the pressed receiving portion is reduced compared with a cross section of the gripping element outside the receiving portion, that is to say, it has in particular a smaller diameter.

When the receiving portion of the gripping element is pressed, an impression is preferably introduced into the surface of the gripping element. The impression may, for example, have a groove pattern and/or a logo. As a result of the impression, the haptics of the gripping element and/or the bendability of the gripping element can be adjusted. It is further possible by means of the impression to apply information items relating to the manufacturer of the cleaning apparatus or the size of the cleaning element to the gripping element.

According to an advantageous embodiment of the method, the brush element may have a positive-locking element, in particular one or more barbs, which by pressing the receiving portion are connected, in particular hooked, to the receiving portion. If the brush element comprises a base which is formed from a wire, in order to form a positive-locking element the wire can be bent or folded over before being introduced into the receiving portion. Alternatively, the wire can be twisted with another wire. In this instance, as a result of the additional wire, a positive-locking element which is in the form of a barb can be formed. In a further alternative manner, the wire can be twisted with itself and bent over or folded over.

An advantageous embodiment of the method makes provision for an end of the gripping element opposite the receiving portion to be pressed. Preferably, the end opposite the receiving portion is pressed in such a manner that a blade-like region of the gripping element is obtained. Such a blade-like region can be used as a massage portion. Alternatively or additionally, the end of the gripping element opposite the receiving portion is pressed in such a manner that a roughened surface nature is produced. Such a surface may enable the massaging of the tooth flesh. It is further possible using such a massage portion to apply a medication, for example, chlorhexidine (CHX) or a fluoride. Alternatively, the end opposite the receiving portion may be pressed in such a manner that an end is constructed in an acutely tapering manner so that a toothpick portion is formed.

Preferably, in order to form the gripping element, a colored fiber material, for example, a colored paper is used. Via the color, alternatively or additionally information items relating to the manufacturer of the interdental cleaning apparatus or the size of the brush element can be introduced into the gripping element. Alternatively or additionally, the fiber material, in particular the paper, may be printed, for example, with a pattern, a logo and/or a marking.

According to an advantageous embodiment of the method according to the invention, there is provision for the cleaning element, to be produced, in particular by means of a cleaning element production machine and for the cleaning element to be connected to the gripping element directly after the cleaning element has been produced. In particular, between the method step of producing the cleaning element and the method step of connecting the cleaning element to the gripping element, there is no method step of accumulating a plurality of cleaning elements produced. This method affords the advantage that a complex separation of cleaning elements produced is not required since the individual cleaning elements are in each case directly connected to a gripping element after they have been produced. Preferably, the connection of the cleaning element to the gripping element is carried out in the same machine as the production of the cleaning element, in particular in the same cleaning element production machine. Alternatively, it is preferable when the cleaning element production machine used to produce the cleaning element is coupled directly to a connection machine, by means of which the cleaning element produced is connected to a gripping element. The coupling of the cleaning element production machine to the connection machine can be carried out by means of a conveying device or a bridge or a hose.

The advantageous embodiments and features described above in relation to the method for producing the cleaning apparatus can also be used alone or in combination for the cleaning apparatus.

The cleaning apparatus is preferably in the form of an interdental cleaning apparatus. Alternatively, the cleaning apparatus may be in the form of a toothbrush or a paintbrush.

Further details, features and advantages of the invention will be appreciated from the drawings and from the following description of preferred embodiments with reference to the drawings. In this instance, the drawings illustrate only exemplary embodiments of the invention which do not limit the notion of the invention.

### BRIEF DESCRIPTION OF THE FIGURES

FIG. 1 shows a cleaning apparatus according to a first exemplary embodiment of the invention as a schematic side view.

FIG. 2 shows the cleaning apparatus according to FIG. 1 as a schematic sectioned illustration.

FIG. 3 shows a cleaning apparatus according to a second exemplary embodiment of the invention as a schematic side view.

FIG. 4 shows the cleaning apparatus according to FIG. 3 as a schematic sectioned illustration.

FIG. 5 shows the cleaning apparatus according to FIG. 1 as a schematic sectioned illustration, wherein the receiving portion of the gripping element is heated and/or pressed.

FIG. 6 shows the cleaning apparatus according to FIG. 5 as a sectioned illustration, after the heating and/or pressing is complete.

FIG. 7 shows a cleaning apparatus according to a third exemplary embodiment of the invention as a schematic sectioned illustration.

FIG. 8 shows a cleaning apparatus according to a fourth exemplary embodiment of the invention as a schematic sectioned illustration.

FIG. 9 shows a flow chart of a first exemplary embodiment of a method according to the invention.

FIG. 10 shows a flow chart of a second exemplary embodiment of a method according to the invention.

FIG. 11 shows a flow chart of a third exemplary embodiment of a method according to the invention.

FIG. 12 shows a flow chart of a fourth exemplary embodiment of a method according to the invention.

### DETAILED DESCRIPTION

In the various Figures, identical components are always given the same reference numerals and are therefore generally also only cited or mentioned once.

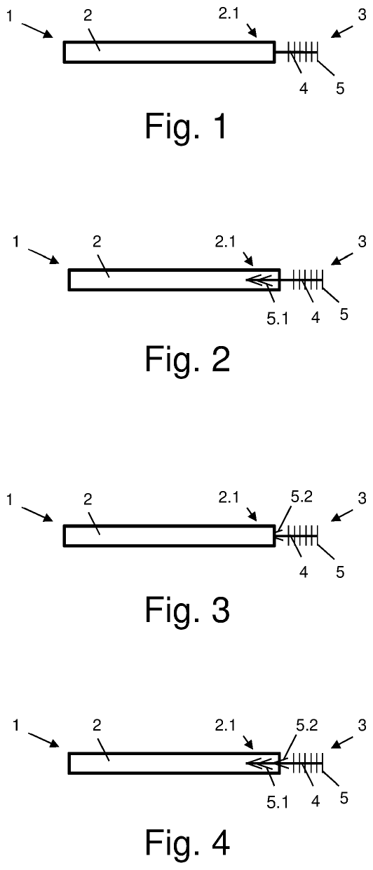

The illustrations in FIGS. 1 and 2 show a cleaning apparatus 1 which is in the form of an interdental cleaning apparatus according to an exemplary embodiment of the invention. The interdental cleaning apparatus 1 comprises a gripping element 2 which is formed from a fiber material, in particular from paper or card. Another component of the interdental cleaning apparatus 1 is a cleaning element 3 which is in the form of a brush element and which is connected to the gripping element 2.

The gripping element 2 has a cylindrical or rod-like form and is preferably formed from rolled or wound paper. The paper can be provided with a heat-sealable coating before the gripping element 2 is formed. At a first front end, there is provided a receiving portion 2.1 in which the brush element 3 is received. In the embodiment, a second end of the gripping element 2 which is arranged opposite the first end, is in the form of a free end with a substantially smooth end face. According to a modification of the exemplary embodiment, there may be provision for there to be provided at the second end a massage portion which has a shaping and/or a surface nature which enables the tooth flesh to be massaged with the massage portion. To this end, for example, the second end may be configured in a blade-like manner and/or have a rough surface. With such a massage portion, a medication can be applied, for example, chlorhexidine (CHX) or a fluoride. Alternatively, at the second end there may be provided a toothpick portion which is constructed in an acutely tapering manner.

The brush element 3 of the interdental cleaning apparatus 1 comprises a base 4 and filaments 5 which are arranged on the base. The filaments are formed from a thermoplastic material, in particular from a polyamide (PA), polylactide (PLA), polymethyl methacrylate (PMMA), polycarbonate (PC), polyethylene terephthalate (PET), polybutylene terephthalate (PBT), polyurethane (PU), polyethylene (PE), polypropylene (PP), polystyrene (PS), polyetheretherketone (PEEK) or polyvinyl chloride (PVC). In this exemplary embodiment, the base 4 is in the form of a straight wire, the main extent direction of which is arranged parallel with a main axis of the gripping element 2. The filaments 5 are inserted and/or woven into the base 4 and extend substantially perpendicularly to the main extent direction of the base 4. Some filaments 5.1 of the brush element 3 are arranged completely in the receiving portion 2.1 of the gripping element 2 and pressed and/or melted with the receiving portion 2.1. The gripping element 2 and the brush element 3 are thereby connected to each other.

FIGS. 3 and 4 show a second exemplary embodiment of a cleaning apparatus 1 according to the invention which is in the form of an interdental cleaning apparatus. This exemplary embodiment substantially corresponds to the exemplary embodiment shown in FIGS. 1 and 2, for which reason reference may be made to the description of these Figures. In contrast to the first exemplary embodiment, in the cleaning apparatus according to the second exemplary embodiment only a portion 5.1 of some filaments of the entirety of the filaments 5 of the brush element 3 is arranged in the receiving portion 2.1. A plurality of filaments 5.2 are arranged, in particular bent over, in such a manner that they protrude from the receiving portion 2.1

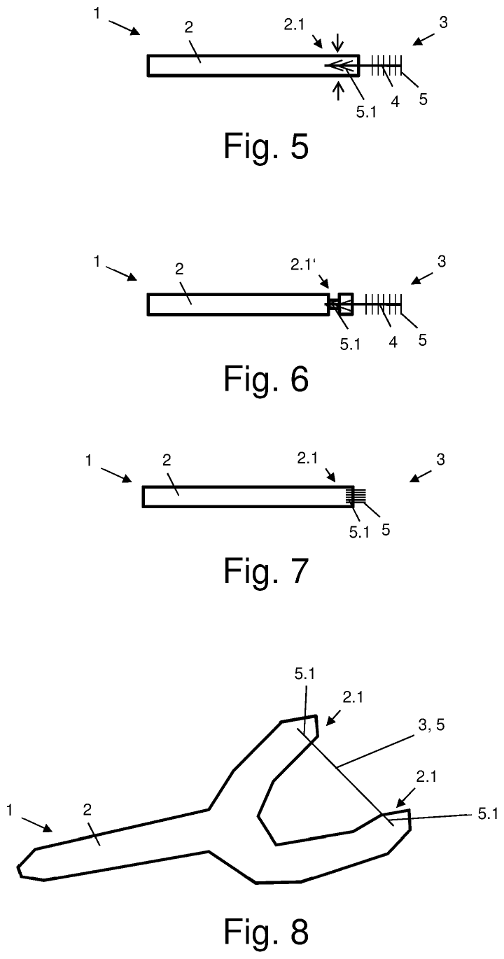

The illustration in FIG. 5 shows an exemplary embodiment of a cleaning apparatus 1 which is in the form of an interdental cleaning apparatus during the production operation, wherein the receiving portion 2.1 of the gripping element 2 is pressed, in particular from several sides, against the filaments 5.1 which are arranged in the receiving portion 2.1. The pressing of the receiving portion 2.1 can be carried out by means of a plurality of, for example, two pressing jaws which are moved toward each other. The pressing jaws may have a surface structure via which during the pressing operation an engraving is introduced into the surface of the receiving portion 2.1, for example, a groove structure or a logo. Optionally, during the pressing operation, heat is introduced into the receiving portion 2.1 and/or the filaments 5.1 which are arranged in the receiving portion 2.1. In order to simultaneously press and introduce heat, a heating element which is brought into contact with the receiving portion, in particular a heatsealing jaw can be used. Alternatively, in order to simultaneously press and introduce heat, an ultrasound sonotrode can be brought into contact with the receiving region. In a further alternative manner, the heat can be introduced by heating the end region of the gripping element 2 which is opposite the receiving portion 2.1 or by heating the base 4 of the brush element 3 or the heat can be introduced by means of heated air.

With reference to FIG. 5, it can clearly be seen that an embodiment may be advantageous in which the brush element 3 comprises first filaments 5 having a relatively high melting point and second filaments 5.1 having a low melting point and the first filaments 5 having the higher melting point are arranged at a side of the brush element 3 which faces away from the gripping element 2, in particular the receiving portion 2.1 of the gripping element 2. This is because, when heat is introduced into the receiving portion 2.1, the heat acts primarily on the second filaments 5.1 which are arranged in the receiving portion 2.1 and which have the low melting point. The filaments 5 which are further away from the receiving portion 2.1 and consequently the introduction location of the heat are, as a result of their distance from the receiving portion 2.1 and the higher melting point thereof, less likely to be impaired by the heat which is introduced into the receiving portion 2.1. Alternatively, there may be provision for the filaments 5 which are arranged outside the receiving portion 2.1 to be cooled whilst the heat is introduced into the receiving portion 2.1. The cooling may, for example, be carried out by means of cold air or water.

From the illustration in FIG. 5, it can further be seen that the receiving portion 2.1 comprises an end face of the gripping element 2 and the pressing and/or introduction of the heat is carried out in a region of the receiving portion 2.1 of the gripping element 2 which has a spacing from the end face of the gripping element 2. This spacing is preferably at least 0.1 times the length of the brush element 3, in particular the base 4, preferably at least 0.25 times the length of the brush element 3, in particular the base 4.

FIG. 6 shows a cleaning apparatus 1 which—as shown in FIG. 4—has been processed by means of pressing and where applicable introduction of heat. As a result of the pressing, a pressed receiving portion 2.1′ which is illustrated in this instance in an excessively powerfully pressed-in manner has been produced. The pressed receiving portion 2.1′ may have two substantially parallel surfaces. The pressed receiving portion 2.1′ has in comparison with a non-pressed receiving portion 2.1 a greater cohesion with the brush element 3.

FIG. 7 shows a third exemplary embodiment of a cleaning apparatus 1 according to the invention which is in the form of a paintbrush or tooth brush. In contrast to the first two exemplary embodiments, in the cleaning apparatus according to the third exemplary embodiment of all the filaments 5 of the brush element 3 a portion 5.1 is arranged in the receiving portion 2.1. All the filaments 5 of the brush element 3 thus protrude from the receiving portion 2.1.

Optionally, the filaments 5 of the brush element 3 may be connected to each other, in particular welded to each other, before the filaments of the brush element 3 are introduced into the receiving portion 2.1. In this manner, an undesirable sliding out of individual filaments can be prevented. Alternatively, the filaments 5 can be connected to each other before being introduced into the receiving portion 2.1 using a connection element, for example, a mount. The connection element can then also be connected to the gripping element, for example, by means of pressing and/or introduction of heat.

FIG. 8 shows a fourth exemplary embodiment of a cleaning apparatus 1 according to the invention which is in the form of a dental floss cleaning apparatus. The cleaning apparatus 1 comprises a gripping element 2 which is configured in a fork-like manner. The gripping element 2 comprises precisely two receiving portions 2.1 for connection of a filament 5 of the cleaning element 3. The filament 5 is in the form of a dental floss filament and in both receiving regions 2.1 pressed and/or melted with the gripping element 2.

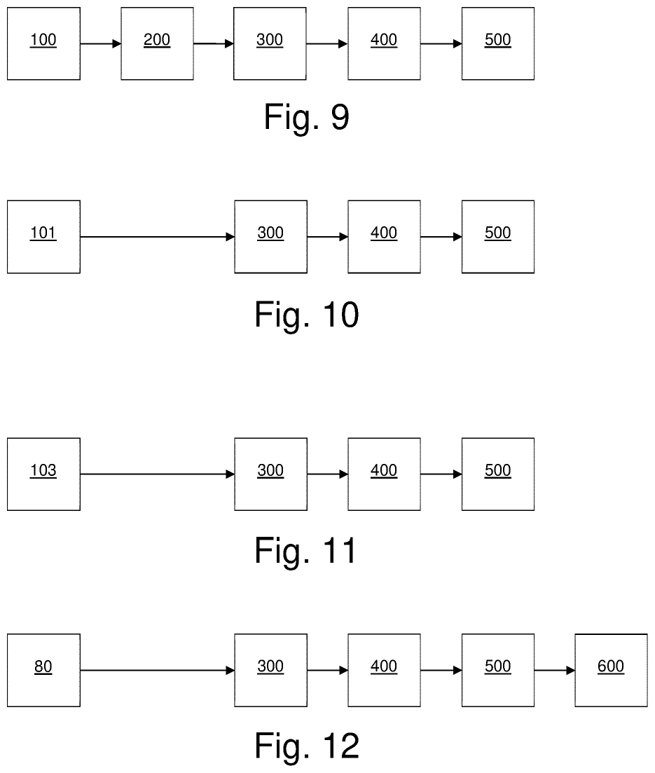

With reference to the illustrations in FIGS. 9 to 12, a plurality of exemplary embodiment of a method for producing an interdental cleaning apparatus 1 from a gripping element 2 and a brush element 3 are intended to be described below, wherein the gripping element 2 is made from a fiber material, in particular from paper or card, and the brush element 3 is connected to the gripping element 2. The connection of the brush element 3 to the grouping element 2 is carried out by
i. pressing the receiving portion 2.1 of the gripping element 2, in particular pressing the receiving portion 2.1 from several sides against the filaments 5.1 or portions 5.1 of the filaments 5 which are arranged in the receiving portion 2.1
and/or
ii. introducing heat into the receiving portion 2.1 and/or the filaments 5.1 or portions 5.1 of the filaments 5 which are arranged in the receiving portion 2.1.

FIG. 9 shows a flow chart of a first exemplary embodiment of such a method for producing a cleaning apparatus 1. According to the first exemplary embodiment—in a method step of rolling 100—the gripping element 2 is initially formed by rolling or winding up the fiber material. A substantially rod-like, cylindrical gripping element 2 which is constructed in the manner of a shaft is obtained. Alternatively to the rollers 100, the method step in which the gripping element 2 is formed by means of fiber pulp molding can be used.

In a method step 200 which follows the rolling 100, the receiving portion 2.1 of the gripping element 2 is produced. This can be carried out in that a blind hole is drilled into an end face of the gripping element 2. Alternatively, the blind hole is produced by pressing a mandrel into the end face of the gripping element 2. In this regard, in the method step 200, a receiving member for the brush element 3 is produced in the gripping element 2.

In a method step of provision 300, a brush element 3 which comprises a plurality of filaments 5 is provided.

In a method step of introduction 400, at least a portion 5.1 of at least some of the filaments 5 of the brush element 3 is then arranged in a receiving portion 2.1 of the gripping element 2. This may, for example, be carried out by the brush element 3 being moved in the direction of the gripping element 2 and being introduced partially into the receiving portion 2.1, in particular into the blind hole of the receiving portion 2.1. Preferably, the portion of the brush element 3 which is introduced into the receiving portion 2.1 completely fills the blind hole of the receiving portion 2.1.

In a method step of connection 500 which follows the introduction 400, the brush element 3 is connected to the gripping element 2. In this instance, the receiving portion 2.1 of the gripping element 2 is pressed. Alternatively or additionally, heat is introduced into the filaments 5.1 or portions 5.1 of the filaments 5 which are arranged in the receiving portion 2.1. The connection 500 can be carried out as explained, for example, in connection with FIGS. 5 and 6.

FIG. 10 shows a flow chart of a second exemplary embodiment of a method for producing an interdental cleaning apparatus 1. In this exemplary embodiment, in a method step of rolling 101, the gripping element 2 is initially formed by rolling or winding up the fiber material, wherein the fiber material is rolled or wound in such a manner about an in particular virtual winding axis that a hollow space is formed along the winding axis. In the method step 101, the gripping element 2 and the receiving portion 2.1 of the gripping element 2 are thus produced at the same time.

In a method step of provision 300, a brush element 3 which comprises a plurality of filaments 5 is provided.

In a method step of introduction 400, at least a portion 5.1 of at least some of the filaments 5 of the brush element 3 is then arranged in a receiving portion 2.1 of the gripping element 2. This may, for example, be carried out by the brush element 3 being moved in the direction of the gripping element 2 and being partially introduced into the receiving portion 2.1, in particular into the blind hole of the receiving portion 2.1. Preferably, the portion of the brush element 3 which is introduced into the receiving portion 2.1 completely fills the blind hole of the receiving portion 2.1.

In a method step of connection 500 which follows the introduction 400, the brush element 3 is connected to the gripping element 2. In this instance, the receiving portion 2.1 of the gripping element 2 is pressed. Alternatively or additionally, heat is introduced into the filaments 5.1 or portions 5.1 of the filaments 5 which are arranged in the receiving portion 2.1. The connection 500 can be carried out as explained, for example, in connection with FIGS. 5 and 6.

FIG. 11 shows a flow chart of a third exemplary embodiment of a method for producing an interdental cleaning apparatus 1. In this embodiment, the fiber material, in particular the paper, is initially rolled in a method step of rolling 103 in order to form the gripping element 2. The fiber material is moistened before and/or during the rolling so that a water content greater than 15%, preferably greater than 20%, in a particularly preferred manner greater than 30%, is adjusted in the fiber material.

Directly after the rolling 103, that is to say, in a non-dried state, in which the water content in the fiber material is greater than 15%, preferably greater than 20%, in a particularly preferred manner greater than 30%, in a subsequent method step of introduction 401 the brush element 3 is partially pressed into the gripping element 3 and in this instance the receiving portion 2.1 of the gripping element 2 is produced.

In a method step of provision 300, a brush element 3 which comprises a plurality of filaments 5 is provided.

In a method step of introduction 400, at least a portion 5.1 of at least some of the filaments 5 of the brush element 3 is then arranged in a receiving portion 2.1 of the gripping element 2. This may, for example, be carried out by the brush element 3 being moved in the direction of the gripping element 2 and being introduced partially into the receiving portion 2.1, in particular the blind hole of the receiving portion 2.1. Preferably, the portion of the brush element 3 which is introduced into the receiving portion 2.1 completely fills the blind hole of the receiving portion 2.1.

In a method step of connection 500 which follows the introduction 400, the brush element 3 is connected to the gripping element 2. In this instance, the receiving portion 2.1 of the gripping element 2 is pressed. Alternatively or additionally, heat is introduced into the filaments 5.1 or portions 5.1 of the filaments 5 which are arranged in the receiving portion 2.1. The connection 500 can be carried out as explained, for example, in connection with FIGS. 5 and 6.

FIG. 12 shows a fourth exemplary embodiment of a method for producing a cleaning apparatus 1. In this exemplary embodiment, a plate-like upper portion element and a plate-like lower portion element are initially provided, wherein the plate-like upper portion element and/or the plate-like lower portion element is/are provided with a heat-sealable coating, cf. method step 80. A portion of the upper portion element forms during the subsequent method a gripping element upper portion and a portion of the lower portion element forms in the subsequent method a gripping element lower portion.

In a method step of provision 300, a brush element 3 which comprises a plurality of filaments 5 is provided.

In a method step 400, the brush element 3 is then partially introduced between the gripping element upper portion and the gripping element lower portion.

In a method step of connection 500 which follows the introduction 400, the brush element 3 is connected to the gripping element 2. In this instance, the receiving portion 2.1 of the gripping element 2 is pressed. Alternatively or additionally, heat is introduced into the filaments 5.1 or portions 5.1 of the filaments 5 which are arranged in the receiving portion 2.1. The connection 500 can be carried out as explained, for example, in connection with FIGS. 5 and 6.

Finally, in a method step of separation 600 which follows the pressing, the gripping element 2, in particular the gripping element upper portion and the gripping element lower portion, is released from the respective upper portion element or lower portion element. The release is preferably carried out by means of punching.

In the production method according to the fourth exemplary embodiment, a plurality of cleaning apparatuses 1 can be produced at the same time. To this end, in the method step 400, a plurality of brush elements 3 are in each case partially introduced between the gripping element upper portion and the gripping element lower portion. The brush elements 3 are then connected to the gripping elements 2. In the separation step, a plurality of gripping elements 2 can be released from the respective upper portion element or lower portion element at the same time or one after the other, for example, by means of punching.

According to a modification of the fourth exemplary embodiment, the separation 600 can be carried out prior to the connection 500.

The method according to the fourth exemplary embodiment or the modification thereof can according to another modification also be used to produce the cleaning apparatus 1 shown in FIG. 8 in the form of a dental floss cleaning apparatus. In this instance, a plate-like upper portion element and a plate-like lower portion element are also provided initially. The platelike lower portion element and/or the plate-like lower portion element is provided with a heatsealable coating, cf. method step 80. A portion of the upper portion element forms in the subsequent method a gripping element upper portion and a portion of the lower portion element forms in the subsequent method a gripping element lower portion.

In a method step of provision 300, a cleaning element 3 which involves precisely one filament 5, in particular comprises precisely one filament 5 is provided.

In a method step 400, the two end portions of the cleaning element 3 are then introduced between the gripping element upper portion and the gripping element lower portion.

In a method step of connection 500 which follows the introduction 400, the cleaning element 3 is connected to the gripping element 2. In this instance, the receiving portion 2.1 of the gripping element 2 is pressed. Alternatively or additionally, heat is introduced into the portions 5.1 of the filament 5 which are arranged in the receiving portion 2.1. The connection 500 can be carried out as explained, for example, in connection with FIGS. 5 and 6.

Finally, in a method step of separation 600 which follows the pressing, the gripping element 2, in particular the gripping element upper portion and the gripping element lower portion are released from the respective upper portion element or lower portion element. The release is preferably carried out by means of punching.

In the exemplary embodiments of the method according to the invention described above for producing a cleaning apparatus 1, there is preferably provision for the cleaning element 3 to be produced in a cleaning element production machine and connected to the gripping element 2 directly after the production so that a collection of cleaning elements 3 produced and subsequent separation of the collected cleaning elements 3 can be dispensed with.

### LIST OF REFERENCE NUMERALS

1 Cleaning apparatus
2 Gripping element
2.1 Receiving portion
2.1′ Pressed receiving portion
3 Cleaning element
4 Base
5 Filament(s)
5.1 Portions of the filament(s) or filaments in the receiving portion
5.2 Portions of the filaments or filaments which protrude from the receiving portion
90 Method step
100, 101, 102 Method step “rolling”
200 Forming blind hole
300 Method step “providing a brush element”
400, 401 Method step “introducing”
500 Method step “pressing and/or introducing heat”
600 Method step “separating”

1. A method for producing a cleaning apparatus or an interdental cleaning apparatus the method comprising:
a. forming a gripping element from a fiber material or from paper or card,
b. providing a cleaning element which comprises at least one filament,
c. arranging at least a portion of the at least one filament of the cleaning element in a receiving portion of the gripping element,
d. connecting the cleaning element to the gripping element by,
i. pressing the receiving portion of the gripping element, or pressing the receiving portion from several sides against the portion, which is arranged in the receiving portion of the filament
and/or
ii. introducing heat into the receiving portion and/or the portion of the filament.

2. The method as claimed in claim 1, wherein
the cleaning element is a brush element which comprises a plurality of filaments
the arranging step comprises the arrangement of at least the portion of at least some of the plurality of filaments of the brush element in a receiving member of the gripping element, and
the connecting step comprises:
i. pressing the receiving portion of the gripping element or pressing the receiving portion from several sides against the filaments or portions of the filaments arranged in the receiving portion,
and/or
ii. introducing heat into the receiving portion and/or the filaments or portions of the filaments which are arranged in the receiving portion.

3. The method as claimed in claim 1, wherein
the arranging step comprises arranging at least two portions or two end portions of the filament, in each case in one of two receiving portions of the gripping element, and
the connecting step comprises
i. pressing the receiving portions of the gripping element or pressing the receiving portions from several sides against the portion of the filament which are arranged in the receiving portion
and/or
ii. introducing heat into the receiving portions and/or the portions of the filament.

4. The method as claimed in claim 1, wherein the one or more filaments are formed from a thermoplastic material.

5. The method as claimed in claim 1, wherein the brush element comprises filaments with a relatively high melting point and filaments with a low melting point and the filaments with the relatively high melting point are arranged at a side of the brush element which faces away from the gripping element or the receiving portion of the gripping element.

6. The method as claimed in claim 1, wherein the heat is introduced by means of a heating element which is brought into contact with the receiving portion or a heat-sealing jaw or a roller.

7. The method as claimed in claim 1, wherein the heat is introduced by means of heated air.

8. The method as claimed in claim 1, wherein the heat is introduced by means of ultrasound.

9. The method as claimed in claim 1, wherein the heat is introduced by heating an end region of the gripping element which is opposite the receiving portion.

10. The method as claimed in claim 1, wherein the fiber material or prior to forming the gripping element, is provided with a heat-sealable coating.

11. The method as claimed in claim 1, wherein the brush element has a base on which the filaments are arranged, or a base made of a metal and/or a plastics material.

12. The method as claimed in claim 11, wherein the heat is introduced by heating the base.

13. The method as claimed in claim 12, wherein the filaments or portions of the filaments of the brush element which are not arranged in the receiving portion are cooled or are cooled by means of air.

14. The method as claimed in claim 1, wherein, when the receiving portion of the gripping element is pressed, an impression is introduced into the surface of the gripping element.

15. The method as claimed in claim 1, wherein the gripping element is constructed in a rod-like manner and the receiving portion of the gripping element is arranged at a front end of the rod-like gripping element.

16. The method as claimed in claim 1, wherein the receiving portion comprises an end face of the gripping element and the pressing and/or introduction of heat is carried out in a region of the receiving portion of the gripping element which has a spacing from the end face of the gripping element or wherein the spacing is at least 0.1 times a length of the cleaning element or the brush element, or the spacing is at least 0.25 times the length of the cleaning element or the brush element.

17. The method as claimed in claim 1, wherein the gripping element or the receiving portion of the gripping element, is moistened or softened.

18. The method as claimed in claim 1, wherein the fiber material or the paper is rolled in order to form the gripping element.

19. The method as claimed in claim 1, wherein the gripping element is in a form of a fiber molded component by means of fiber pulp molding from the fiber material.

20. The method as claimed in claim 1, wherein at least one filament which is arranged in the receiving portion is arranged or is bent over; in such a manner that it protrudes from the receiving portion or at an end face of the gripping element.

21. A cleaning apparatus or an interdental cleaning apparatus, having a gripping element and a cleaning element which comprises at least one filament, wherein the gripping element is made from a fiber material or from paper or card, and the cleaning element is connected to the gripping element, wherein at least a portion of the at least one filament is arranged in a receiving portion of the gripping element and is pressed and/or melted with the receiving portion.
